(19) United States
(12) Patent Application Publication
(10) Pub. No.: US 2024/0029306 A1
(43) Pub. Date: Jan. 25, 2024

(54) METHODS, SYSTEMS, APPARATUS, AND ARTICLES OF MANUFACTURE FOR MONOCULAR DEPTH ESTIMATION

(71) Applicants: Shariq Farooq Bhat, Thuwal (SA); Diana Wofk, Munich (DE); Reiner Birkl, Munich (DE); Matthias Mueller, Munich (DE); Peter Wonka, Thuwal (SA)

(72) Inventors: Shariq Farooq Bhat, Thuwal (SA); Diana Wofk, Munich (DE); Reiner Birkl, Munich (DE); Matthias Mueller, Munich (DE); Peter Wonka, Thuwal (SA)

(21) Appl. No.: 18/478,525

(22) Filed: Sep. 29, 2023

(51) Int. Cl. G06T 7/80; G06T 7/73; G06T 7/55

(52) U.S. Cl. CPC G06T 7/80; G06T 7/75; G06T 7/55; G06T 2207/20081; G06T 2207/10028; G06T 2207/20084

(57) ABSTRACT

Methods, systems, apparatus, and articles of manufacture for monocular depth estimation are disclosed. An example apparatus disclosed herein is to determine bin center positions for a pixel of an image based on first features obtained at a first decoder layer of an encoder-decoder architecture, the image representative of a three-dimensional (3D) scene, the bin center positions corresponding to respective different metric depth values. The example apparatus is also to adjust the bin center positions at a second decoder layer of the encoder-decoder architecture based on an attractor point, the attractor point based on the first features and second features obtained at the second decoder layer. The example apparatus is further to output a metric depth map corresponding to the image, the metric depth map including a metric depth value corresponding to the pixel, the metric depth value based on the adjusted bin center positions.

### FIELD OF THE DISCLOSURE

This disclosure relates generally to computer vision and, more particularly, to methods, systems, apparatus, and articles of manufacture for monocular depth estimation.

### BACKGROUND

The technical fields of computer vision, machine vision, image processing, pattern recognition, and the like, often involve the analysis of one or more images of a scene to extract features indicative of the objects within the scene and/or their spatial relationship to one another. The implementation of such technical disciplines may involve the generation of a depth map associated with the imaged scene. A depth map includes information indicative of the depth and/or distance of different surfaces of objects within the scene relative to a particular viewpoint of the image(s) being analyzed (e.g., relative to the viewpoint of the camera(s) that captured the image(s)). Some depth maps define a value representative of a depth for each pixel in an image of the scene being analyzed. The depth values for individual pixels defined in a depth map are estimations based on an analysis of the underlying image(s) of the scene.

### BRIEF DESCRIPTION OF THE DRAWINGS

FIG. 1 illustrates an example process flow for estimating depth of an example image in accordance with teachings of this disclosure.

FIG. 2 is a block diagram of example depth estimation circuitry to execute the example process flow of FIG. 1.

FIG. 3 illustrates an example bin selection process flow that can be implemented by the example depth estimation circuitry of FIG. 2 to select and/or adjust example bin centers for example pixels of the image of FIG. 1.

FIG. 4 is a flowchart representative of example machine readable instructions and/or example operations that may be executed, instantiated, and/or performed by example programmable circuitry to implement the depth estimation circuitry 200 of FIG. 2.

FIG. 5 is a flowchart representative of example machine readable instructions and/or example operations that may be executed, instantiated, and/or performed by example programmable circuitry to implement the depth estimation circuitry 200 of FIG. 2 to train one or more example neural networks.

FIG. 6 is a block diagram of an example processing platform including programmable circuitry structured to execute, instantiate, and/or perform the example machine readable instructions and/or perform the example operations of FIGS. 4 and/or 5 to implement the depth estimation circuitry 200 of FIG. 2.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIGS. 4 and/or 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

In some computer vision applications, depth information associated with an imaged scene may be analyzed in addition to the texture (e.g., color, brightness, etc.) of an image of the scene. In some examples, such depth information is represented by a depth map or depth image. A depth map may be represented as a two-dimensional array of data with elements corresponding respectively to the two-dimensional array of pixels in an associated image. That is, the value of each element in a depth map corresponds to an individual pixel in the associated image. In some examples, the value of each element in the depth map indicates and/or corresponds to the depth or distance of the surface of the object in the scene represented by the corresponding pixel in the captured image relative to some reference point (e.g., the position of the sensor that captured the image).

In some examples, the values of a depth map can represent metric depth and/or relative depth for corresponding pixels in the captured image. As used herein, metric depth refers to absolute depth values (e.g., in physical units such as meters, inches, etc.) corresponding to the pixels in the image. In contrast, relative depth refers to a ranking and/or ordering of the depth values of the pixels relative to other pixels of the image, with a scale of the depth values being unknown. Stated differently, relative depth refers to scale-invariant ratios and/or relationships between the depth values of corresponding pixels.

In some cases, metric depth of an image is useful for some downstream applications in computer vision and robotics, such as mapping, planning, navigation, object recognition, reconstruction of three-dimensional (3-D) scenes, and/or image editing. However, training a metric depth estimation model across multiple datasets can reduce accuracy of predictions output by the metric depth estimation model, especially when the multiple datasets include images with large variations in depth scale (e.g., indoor images compared to outdoor images). As a result, metric depth estimation models may overfit to specific datasets and, thus, may not generalize well to other datasets. In contrast, by factoring out metric scale, relative depth estimation models can be trained across multiple diverse datasets corresponding to varying depth scales and/or domains (e.g., indoor, outdoor, etc.). As a result, the relative depth estimation models generalize across the different domains without a reduction in accuracy of the relative depth values output by the relative depth estimation models. However, because the relative depth values do not indicate metric scale, the relative depth values may have lower utility in computer vision applications (e.g., compared to metric depth values).

Examples disclosed herein improve metric depth estimation for an image by training an example encoder-decoder architecture (e.g., a. encoder-decoder backbone) for relative depth estimation and adding one or more example heads (e.g., metric heads, prediction heads) trained for metric depth estimation. As used herein, a backbone refers to a feature-extracting neural network (and/or a portion thereof) that processes input data into an example feature representation. As used here, a head (e.g., a head model) refers to a neural network (and/or a portion thereof) that predicts and/or detects one or more example parameters (e.g., depth values) based on the feature representation. In some examples disclosed herein, the encoder-decoder architecture includes an example encoder (e.g., an encoder network) to receive the image as input and extract example features (e.g., feature maps, multi-channel feature maps) from the input image to generate a lower-dimensional representation (e.g., compared to the original spatial dimensions) of the input image. The encoder-decoder architecture further includes an example decoder (e.g., a decoder network) to generate one or more example outputs based on the lower-dimensional, or compressed, representation. In some examples, the outputs include example feature maps (e.g., multi-channel feature maps) at corresponding decoder layers of the decoder, where the decoder layers correspond to respective different spatial resolutions of the input image. In some examples, the decoder performs up-sampling of the feature maps from previous decoder layers to generate the feature map for a current decoder layer, and the feature map at a final decoder layer (e.g., corresponding to the spatial resolution of the input image and/or half the spatial resolution of the input image) is used to generate an example relative depth map corresponding to the input image. Examples disclosed herein utilize a depth prediction transformer (DPT) encoder-decoder architecture trained based on a Multiple Depth Estimation Accuracy with Single Network (MiDaS) framework. In some examples, a different encoder-decoder architecture may be used in addition, or as an alternative, to a DPT encoder-decoder architecture trained based on the MiDaS framework.

In some examples, the feature maps from the different decoder layers are provided to one of the metric heads corresponding to a domain type (e.g., indoor or outdoor) of the input image. Example depth estimation circuitry disclosed herein estimates, based on the feature maps and the relative depth map output by the encoder-decoder architecture, example metric depth values for one or more pixels of the input image. For example, the depth estimation circuitry executes, based on a first feature map corresponding to a first decoder layer (e.g., at a bottleneck of the encoder-decoder architecture), one or more example neural networks to determine example bin center positions for the pixel(s). In some examples, the bin center positions correspond to respective depth values (e.g., a depth distribution) along an example depth interval. In some examples, the depth estimation circuitry determines one or more attractor points for one or more subsequent decoder layers, and the depth estimation circuitry iteratively adjusts the bin center positions across the subsequent decoder layers based on differences between the attractor points and the bin center positions.

In some examples, the depth estimation circuitry determines the metric depth values for the corresponding pixel(s) based on a linear combination of the bin center positions and corresponding example bin probability values. For example, the depth estimation circuitry determines the bin probability values based on a log binomial distribution, where example parameters (e.g., mode and/or temperature) of the log binomial distribution are determined based on the relative depth map and/or example bin embeddings corresponding to a final decoder layer. In some examples, the depth estimation circuitry outputs an example metric depth map indicating the metric depth values at respective pixels of the image.

Advantageously, by implementing one or more metric heads for metric depth estimation along with an encoder-decoder architecture pre-trained for relative depth estimation, examples disclosed herein achieve a metric depth estimation model that can accurately estimate metric depth values for an image while enabling generalization across multiple datasets and/or domain types. Further, by using attractor points to iteratively adjust bin center positions across subsequent decoder layers, examples disclosed herein gradually refine and/or improve accuracy of resulting metric depth predictions. Additionally, examples disclosed herein utilize a log-binomial distribution to predict the bin probability values across the bin centers, which can result in improved accuracy of the metric depth predictions compared to when other techniques (e.g., a softmax function) are used to predict the bin probability values. By improving the accuracy of estimated metric depth information, examples disclosed herein can improve efficiency of a computing device by improving performance of downstream applications (e.g., computer vision applications, robotics applications, etc.) that utilize the metric depth information. Further, by providing a metric depth estimation model that generalizes across multiple datasets and/or domains, examples disclosed herein reduce a need for re-training of the model and/or for training of multiple models for the different datasets and/or domains, thereby reducing utilization of memory and/or computational power of the computing device.

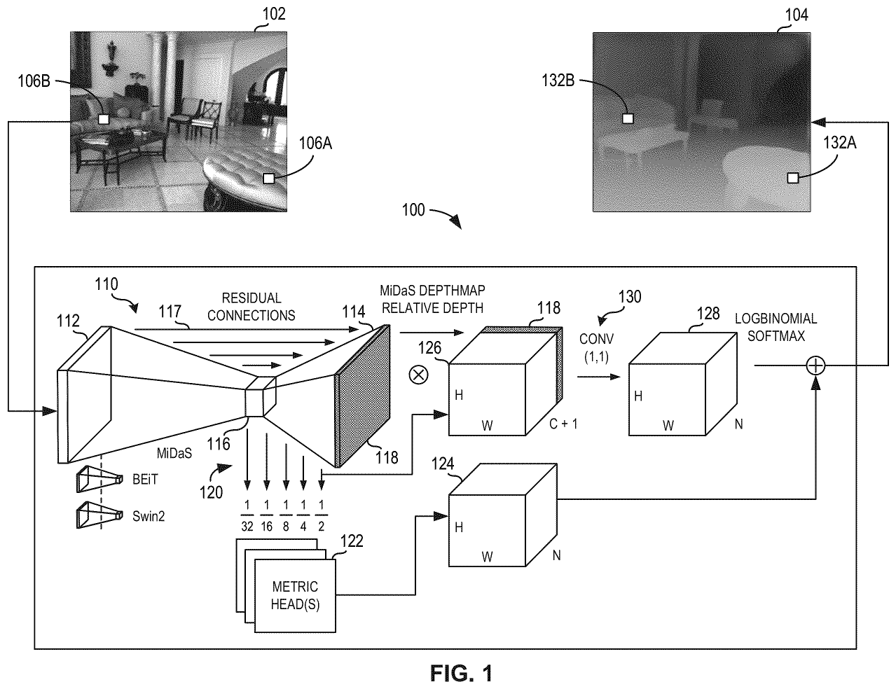

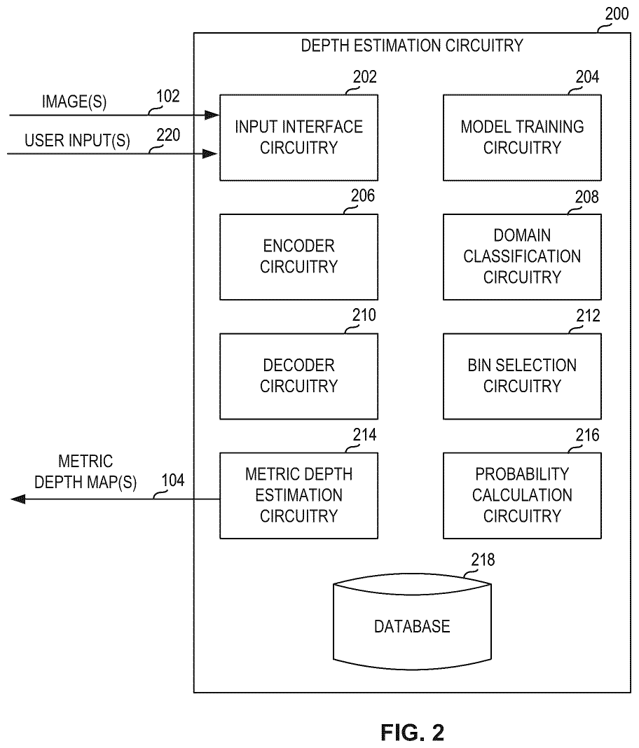

FIG. 1 illustrates an example process flow 100 for estimating metric depth values for an example image (e.g., an input image) 102 in accordance with teachings of this disclosure. The example process flow 100 of FIG. 1 is described from the perspective of being implemented by the example depth estimation circuitry 200 of FIG. 2. In the illustrated example of FIG. 1, an output of the process flow 100 is an example metric depth map 104 corresponding to the image 102, where the metric depth map 104 represents the metric depth values corresponding to respective example pixels 106 of the image 102. In the example of FIG. 1, the image 102 is representative of a 3-D indoor scene, with two of the pixels 106A, 106B of the image 102 enlarged for effect. In this example, the first pixel 106A corresponds to a first example object (e.g., a chair) in the 3-D scene, and the second pixel 106B corresponds to a second example object (e.g., a couch) in the 3-D scene. In this example, the first object is positioned closer to a reference point of the image 102 (e.g., a location of a camera capturing the image 102) compared to the second object. Accordingly, a first example metric depth value corresponding to the first pixel 106A (e.g., a first distance between the reference point and a first surface of the first object corresponding to the first pixel 106A) is less than a second example metric depth value corresponding to the second pixel 106B (e.g., a second distance between the reference point and a second surface of the second object corresponding to the second pixel 106B).

In the illustrated example of FIG. 1, to determine metric depth values corresponding to one or more of the pixels 106 of the image 102, the image 102 is provided as input to an example encoder-decoder architecture 110 implemented by the depth estimation circuitry 200 of FIG. 2. The encoder-decoder architecture 110 of FIG. 1 includes an example encoder (e.g., an encoder network, an encoder model) 112 implemented by example encoder circuitry 206 of FIG. 2 and an example decoder (e.g., a decoder network, a decoder model) 114 implemented by example decoder circuitry 210 of FIG. 2. In this example, the encoder-decoder architecture 110 utilizes a DPT encoder-decoder architecture (e.g., a Bidirectional Encoder representation from Image Transformers (BEiT) model) as a base model (e.g., a backbone), and the base model is trained by example model training circuitry 204 of FIG. 2 using the MiDaS framework for relative depth prediction. In some examples, a different encoder-decoder architecture (e.g., Swin, Swin2, Next-ViT, LeViT, etc.) can be used instead.

In the example of FIG. 1, the image 102 is an RGB image (e.g., a truecolor image), where colors of corresponding ones of the pixels 106 are represented using three channels (e.g., corresponding to red, green, and blue components of the colors). As such, the image 102 is a three-channel input (e.g., having a feature dimensionality of three). In some examples, the image 102 can be represented as an array of size W×H×C, where W and H represent a spatial resolution (e.g., a width and height in pixels) of the image 102, and C represents the number of channels used to store information (e.g., the red, green, and blue color components) for the corresponding pixels 106.

In this example, the encoder 112 accesses the image 102 and extracts example features therefrom to generate an example latent representation (e.g., a feature map) of the image 102. In some examples, the encoder 112 corresponds to one or more encoder layers of a neural network implemented by the encoder-decoder architecture 110, where the encoder 112 extracts and/or identifies the features at the one or more encoder layers. The features can represent, for example, an object to which one or more of the pixels 106 correspond, whether the pixels 106 correspond to a surface or an edge of the object, etc. In some examples, new features are extracted at subsequent one(s) of the encoder layers, and the features are stored in corresponding new channels generated for the latent representation of the image 102. As a result, the feature dimensionality of the latent representation (e.g., the number of channels used to represent per-pixel information and/or features) increases across the encoder layers. Further, at the subsequent one(s) of the encoder layers, the encoder 112 clusters and/or groups regions of the image 102 based on the extracted features, such that the spatial resolution of the latent representation is reduced across the encoder layers. In some examples, the encoder 112 outputs the latent representation at an example bottleneck 116 of the encoder-decoder architecture 110, where the bottleneck 116 corresponds to a final encoder layer of the encoder neural network. In this example, the latent representation at the bottleneck 116 has a reduced spatial resolution (e.g., 1/32, 1/64, 1/128, etc.) compared to the image 102, but a greater feature dimensionality (e.g., 1024 features for the latent representation at the bottleneck 116 compared to three features for the image 102).

In some examples, based on the latent representation at the bottleneck 116, the decoder 114 generates an example relative depth map 118 corresponding to the image 102. For example, the decoder 114 corresponds to one or more example decoder layers of the neural network implemented by the encoder-decoder architecture 110, where the decoder 114 performs up-sampling of the latent representation across the one or more decoder layers. In some examples, the decoder 114 performs the up-sampling using bi-linear interpolation and/or transposed convolutions to increase the spatial resolution of the latent representation between subsequent one(s) of the decoder layers. In some examples, the decoder 114 doubles the spatial resolution between the subsequent one(s) of the decoder layers, and five of the decoder layers (e.g., corresponding to 1/32, 1/16, ⅛, ¼, and ½ of the spatial resolution of the image 102) are used in this example. In some examples, the number of the decoder layers and/or the corresponding spatial resolutions can be different.

Further, as the decoder 114 up-samples the latent representation across the subsequent one(s) of the decoder layers, the decoder 114 reduces the feature dimensionality of the latent representation (e.g., the number of channels and/or features represented per pixel 106). For example, the number of features per pixel can be halved at subsequent one(s) of the decoder layers (e.g., such that the latent representation includes 1024 features per pixel at the bottleneck 116, 512 features per pixel at a first decoder layer, 256 features per pixel at a second decoder layer, etc.). In the example of FIG. 1, the encoder-decoder architecture 110 includes example connections (e.g., residual connections) 117 between the encoder layers of the encoder 112 and the corresponding decoder layers of the decoder 114. In some examples, the extracted features from the encoder layers are provided to the respective decoder layers via the connections 117 to facilitate the up-sampling at the decoder 114.

In the illustrated example of FIG. 1, an output of the decoder 114 is the relative depth map 118 corresponding to the image 102. In some examples, the relative depth map 118 represents the relative depth values for corresponding one(s) of the pixels 106 (e.g., relative to other one(s) of the pixels 106) in the image 102. In this example, a spatial resolution of the relative depth map 118 corresponds to half the spatial resolution of the input image 102. In some examples, the spatial resolution of the relative depth map 118 can be different (e.g., equal to the spatial resolution of the image 102, less than the spatial resolution of the image 102, etc.). In the example of FIG. 1, the decoder 114 further outputs example feature maps 120 corresponding to one(s) of the decoder layers and/or the bottleneck 116. In some examples, the feature maps 120 are arrays representing the per-pixel features of the latent representation of the image 102 determined for the respective decoder layers and/or the bottleneck 116. For example, the decoder 114 outputs a first one of the feature maps 120 including a first number (e.g., 1024) of features (e.g., stored in corresponding channels) per pixel at the bottleneck 116, a second one of the feature maps 120 including a second number (e.g., 512) of features per pixel at a first decoder layer, a third one of the feature maps 120 including a third number (e.g., 256) of features per pixel at a second decoder layer, a fourth one of the feature maps 120 including a fourth number (e.g., 128) of features per pixel at a third decoder layer, and a fifth one of the feature maps 120 including a fifth number (e.g., 64) of features per pixel at a fourth decoder layer. In some examples, the number of the feature maps 120 and/or the corresponding number of features per pixel can be different.

In some examples, based on the first one of the feature maps 120 corresponding to the bottleneck 116, the depth estimation circuitry 200 of FIG. 2 selects one or more example metric heads (e.g., prediction heads, metric bin modules) 122 implemented by the depth estimation circuitry 200. For example, the metric heads 122 can be implemented by the bin selection circuitry 212, the metric depth estimation circuitry 214, and/or the probability calculation circuitry 216 of FIG. 2. In some examples, the metric heads 122 are neural networks (and/or portions thereof) trained on top of the encoder-decoder architecture 110 and include one or more neural network layers to determine and/or output example bin centers (e.g., bin center positions, depth interval values) along an example depth interval for respective one(s) of the pixels 106. In some examples, the depth interval is divided into multiple example bins that can have variable width, and the bin centers identify the centers of corresponding ones of the bins. In some examples, the bins represent respective example ranges of depth values along the depth interval. In some examples, the bin centers can be used by example metric depth estimation circuitry 214 of FIG. 2 to estimate metric depth value(s) for the one(s) of the pixels 106.

In the illustrated example of FIG. 1, the metric heads 122 are trained by the model training circuitry 204 of FIG. 2 to predict bin centers for images corresponding to respective different example domains (e.g., domain types, settings, environments). For example, the model training circuitry 204 can train a first one of the metric heads 122 based on first images (e.g., indoor images) corresponding to an indoor scene, and can train a second one of the metric heads 122 based on second images (e.g., outdoor images) corresponding to an outdoor scene. In such examples, a variability and/or range of depth values for the indoor images is typically less than the variability and/or range of depth values for the outdoor images. Thus, as a result of training, the first one of the metric heads 122 may predict bin centers along a different depth interval (e.g., a smaller and/or narrower depth interval) compared to the second one of the metric heads 122. By training and/or utilizing multiple metric heads 122 for the respective different domains, the depth estimation circuitry 200 of FIG. 2 can improve accuracy of metric depth estimations determined using the metric heads 122. Further, although two domains (e.g., indoor or outdoor) are used in this example, one or more different domains can be used instead.

In some examples, example domain classification circuitry 208 of the depth estimation circuitry 200 of FIG. 2 executes, based on the first one of the feature maps 120, an example classification model (e.g., a domain classification model, a latent classifier model) to predict the domain of the image 102. In some examples, as a result of the execution, the domain classification circuitry 208 selects one of the metric heads 122 corresponding to the predicted domain, and the domain classification circuitry 208 routes and/or provides the feature maps 120 to the selected metric head 122. In some examples, based on the feature maps 120 and the selected metric head 122, example bin selection circuitry 212 of the depth estimation circuitry 200 of FIG. 2 selects and/or adjusts the bin centers at the bottleneck 116 and/or at ones of the decoder layers.

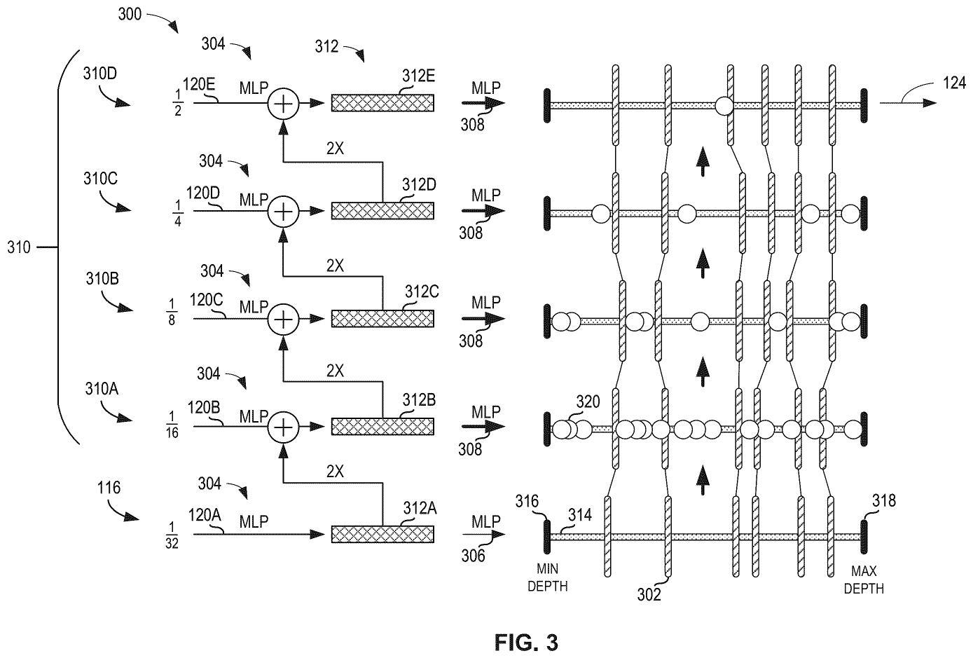

For example, FIG. 3 illustrates an example bin selection process flow 300 that can be implemented by the example bin selection circuitry 212 of FIG. 2 to select and/or adjust example bin centers 302 for one(s) of the example pixels 106 of FIG. 1. In some examples, the bin selection circuitry 212 implements the bin selection process flow 300 of FIG. 3 by executing an example bin selection model (e.g., bin selection neural network layer(s)) corresponding to the selected one of the metric heads 122 of FIG. 1, where the bin selection model includes one or more example bin embedding layers (e.g., bin embedding multilayer perceptrons (MLPs)) 304, one or more example bin initialization layers (e.g., bin initialization MLPs) 306, and one or more example attractor selection layers (e.g., attractor selection MLPs) 308. In some examples, one(s) of the layers 304, 306, 308 correspond to pointwise MLPs (e.g., 1-by-1 convolutional blocks).

In the illustrated example of FIG. 3, the bin selection process flow 300 begins when the bin selection circuitry 212 accesses and/or obtains the example feature maps 120 corresponding to the bottleneck 116 and/or to one or more example decoder layers 310 (e.g., a first decoder layer 310A, a second decoder layer 310B, a third decoder layer 310C, and a fourth decoder layer 310D) of the encoder-decoder architecture 110 of FIG. 1. For example, the bin selection circuitry 212 accesses a first example feature map 120A from the bottleneck 116, a second example feature map 120B from the first decoder layer 310A, a third example feature map 120C from the second decoder layer 310B, a fourth example feature map 120D from the third decoder layer 310C, and a fifth example feature map 120E from the fourth decoder layer 310D.

In some examples, a feature dimensionality (e.g., a number of features and/or channels) of the feature maps 120 can vary between layers (e.g., between the bottleneck 116 and/or the decoder layers 310), and/or can vary based on a type of architecture used for the encoder-decoder architecture 110 of FIG. 1. For example, the feature maps 120 of FIG. 3 include respective different numbers (e.g., 1024, 512, 256, 128, and 64) of features and/or channels representing one(s) of the pixels 106 of FIG. 1. In some examples, to enable generalization of the metric head(s) 122 across multiple architecture types and/or to otherwise ensure the metric head(s) 122 are not architecture-dependent, the bin selection circuitry 212 maps and/or converts the feature maps 120 to corresponding example bin embeddings 312 having a fixed dimensionality (e.g., a fixed number of channels) across the bottleneck 116 and the decoder layers 310. For example, the bin selection circuitry 212 iteratively maps the feature maps 120 to the corresponding bin embeddings 312 based on execution of the bin embedding layers 304. In this example, the bin embeddings 312 have a fixed dimensionality of C channels across the bottleneck 116 and the decoder layers 310, where C can be 128 channels, 256 channels, etc.

In the example of FIG. 3, the bin selection circuitry 212 executes the bin embedding layer(s) 304 based on the first feature map 120A to determine first example bin embeddings 312A corresponding to the bottleneck 116. Further, the bin selection circuitry 212 performs upsampling of the first bin embeddings 312A to increase (e.g., double) the dimensionality thereof, and provides the upsampled first bin embeddings 312A to the first decoder layer 310A. At the first decoder layer 310A, the bin selection circuitry 212 combines (e.g., adds) the upsampled first bin embeddings 312A and the second feature map 120B corresponding to the first decoder 310A, and executes the bin embedding layer(s) 304 based on the combination. As a result of the execution, the bin selection circuitry 212 determines second example bin embeddings 312B corresponding to the first decoder layer 310A, where the first bin embeddings 312A and the second bin embeddings 312B have a same dimensionality (e.g., C). In this example, the bin selection circuitry 212 iteratively performs the upsampling, combination, and execution procedures for subsequent ones of the decoder layers 310 to determine third, fourth, and fifth example bin embeddings 312C, 312D, 312E corresponding to the second, third, and fourth decoder layers 310B, 310C, 310D, respectively.

In the illustrated example of FIG. 3, the bin selection circuitry 212 selects and/or adjusts the bin centers 302 at the bottleneck 116 and/or at the decoder layers 310 based on the corresponding bin embeddings 312. For example, the bin selection circuitry 212 executes the bin initialization layer(s) 306 based on the first bin embeddings 312A to determine initial positions for the bin centers 302 along an example depth interval (e.g., a depth range) 314. In this example, the depth interval 314 is defined between an example lower depth value (e.g., a minimum depth value) 316 and an example upper depth value (e.g., a maximum depth value) 318, where the lower and upper depth values 316, 318 are based on the domain of the selected metric head 122 of FIG. 1. In some examples, the depth interval 314 is the same across the bottleneck 116 and the decoder layers 310, while the positions of the bin centers 302 may vary therebetween. In some examples, the bin centers 302 represent a local distribution of depth values (e.g., metric depth values) for a corresponding pixel 106 of the image 102 of FIG. 1. In some examples, bin sizes (e.g., bin widths) corresponding to the bin centers 302 can vary across the depth interval 314, and concentrations (e.g., clustering) of the bin centers 302 at one or more locations along the depth interval 314 can represent frequency and/or likelihood of corresponding depth values for the pixel 106. Although six of the bin centers 302 are shown in the example of FIG. 3, a different number of the bin centers 302 (e.g., 32, 64, 128, etc.) can be used instead.

In the example of FIG. 3, the bin selection circuitry 212 utilizes information (e.g., the bin embeddings 312) available at subsequent ones of the decoder layers 310 to iteratively adjust and/or refine the positions of the bin centers 302 across the decoder layers 310. Stated differently, the bin selection circuitry 212 can improve accuracy of the depth distribution for the pixel 106 by leveraging different information available to the bin selection circuitry 212 at the different decoder layers 310. In the example of FIG. 3, to adjust the positions of the bin centers 302 at the decoder layers 310, the bin selection circuitry 212 selects and/or determines locations for one or more example attractors (e.g., attractor points) 320 along the depth interval 314. For example, the bin selection circuitry 212 executes the attractor selection layer(s) 308 based on the second bin embeddings 312B to determine the locations of the attractors 320 along the depth interval 314 for the first decoder layer 310A. In some examples, the attractors 320 are points along the depth interval 314 toward which the bin centers 302 are attracted and/or shifted at corresponding one(s) of the decoder layers 310.

In some examples, the bin selection circuitry 212 determines adjusted positions for the bin centers 302 at the first decoder layer 310A based on differences between the initial positions (e.g., first positions) for the bin centers 302 (e.g., from the bottleneck 116) and the attractors 320. For example, the bin selection circuitry 212 determines the adjusted position for an i^{th} one of the bin centers 302 (e.g., where i=1, N, and N is the total number of the bin centers 302) based on example Equation 1 below.

c′ᵢ=cᵢ+Δcᵢ (Equation 1)

In example Equation 1 above, c′ᵢ represents the adjusted position for the one of the bin centers 302 along the depth interval 314, cᵢ represents the initial position for the i^{th} one of the bin centers 302 along the depth interval 314, and Δcᵢ represents an example adjustment value for the one of the bin centers 302. In some examples, the bin selection circuitry 212 determines the adjustment value (e.g., Δcᵢ) based on an example inverse attractor equation shown in example Equation 2 below.

$$Δ {c}_{i} = {\sum }_{k = 1}^{{n}_{a}} \frac{{a}_{k} - {c}_{i}}{1 + α {\vert {a}_{k} - {c}_{i} \vert}^{γ}} \qquad ( Equation 2 )$$

In example Equation 2 above, nₐ represents a total number of the attractors 320 for a corresponding decoder layer 310, aₖ represents the position of a k^{th} one of the attractors 320 along the depth interval 314, and a and γ represent example hyperparameters that determine strength of the attractors 320. Values for the hyperparameters can be present in the bin selection circuitry 212 and/or can be selected based on example user input(s) 220 to the depth estimation circuitry 200 of FIG. 2. In this example, α=300 and γ=2. In some examples, one or more of the hyperparameter values can be different.

In some examples, instead of using the inverse attractor equation shown in Equation 2 above, the bin selection circuitry 212 can determine the adjustment value Δcᵢ based on an example exponential attractor equation shown in example Equation 3 below.

Δcᵢ=Σₖ₌₁ⁿ^{ₐ}(aₖ−cᵢ)e^{-α|a}^{ₖ}^{-c}^{ᵢ}^{|}^{^{γ}} (Equation 3)

In some examples, the bin selection circuitry 212 can select one of the inverse attractor equation (shown in example Equation 2 above) or the exponential attractor equation (shown in example Equation 3 above) based on the user input(s) 220 to the depth estimation circuitry 200 of FIG. 2. In such examples, the bin selection circuitry 212 determines the adjustment value Δcᵢ based on the selected one of the inverse attractor equation or the exponential attractor equation. In some examples, the bin selection circuitry 212 determines the adjustment value based on a combination (e.g., an average) of the adjustment values from the inverse attractor equation and the exponential attractor equation.

In the illustrated example of FIG. 3, the bin selection circuitry 212 evaluates example Equation 1 and at least one of example Equations 2 or 3 above for corresponding one(s) of the bin centers 302 to determine the adjusted positions (e.g., second positions) of the bin centers 302 at the first decoder layer 310A. Similarly, the bin selection circuitry 212 evaluates the example Equations 1, 2, and/or 3 above for subsequent one(s) of the decoder layers 310 to iteratively adjust the positions of the bin centers 302 at the subsequent one(s) of the decoder layers 310. In some such examples, the bin selection circuitry 212 determines the attractor points 320 at the subsequent one(s) of the decoder layers 310 by executing the attractor selection layer(s) 308 based on corresponding one(s) of the bin embeddings 312. In some examples, a number of the attractors 320 may vary across the decoder layers 310, and the number of the attractors 320 per decoder layer 310 can be preset and/or can be selected based on the user input(s) 220 of FIG. 2. In this example, the bin selection circuitry 212 determines sixteen of the attractors 320 for the first decoder layer 310A, eight of the attractors 320 for the second decoder layer 310B, four of the attractors 320 for the third decoder layer 310C, and one of the attractors 320 for the fourth decoder layer 310D. In some examples, the number of the attractors 320 for one or more of the decoder layers 310 can be different.

The example bin selection process flow 300 of FIG. 3 is shown for one of the pixels 106 of the image 102 of FIG. 1. In some examples, the bin selection circuitry 212 performs the bin selection process flow 300 (e.g., in series or in parallel) for corresponding one(s) of the pixels 106 to determine the bin centers 302 for the corresponding one(s) of the pixels 106. In some examples, as a result of executing the bin selection process flow 300 of FIG. 3 for the one(s) of the pixels 106, the bin selection circuitry 212 outputs an example bin array (e.g., a bin matrix) 124 as shown in FIG. 1. In some examples, the bin array 124 represents the bin centers 302 at a final one of the decoder layers 310 (e.g., the fourth decoder layer 310D) for the corresponding one(s) of the pixels 106.

Returning to FIG. 1, an output of the metric head(s) 122 is the example bin array 124 representing the bin centers 302 determined based on the example bin selection process flow 300 of FIG. 3. In the illustrated example of FIG. 1, the bin array 124 is an array of size W×H×N, where W and H represent the width and height in pixels, respectively, of the image 102, and N represents the number of bin centers 302 determined per pixel 106. As such, values along the W×H dimensions represent pixel locations (e.g., two-dimensional pixel coordinates) of the corresponding pixels 106 in the image 102, and values along the N dimension represent the bin centers 302 for the corresponding pixels 106.

In the example of FIG. 1, an output of the encoder-decoder architecture 110 is an example output array (e.g., an output matrix) 126 representing final bin embeddings (e.g., the fifth bin embeddings 312E corresponding to the fourth decoder layer 310D) and the relative depth values output by the decoder 114. For example, the decoder circuitry 210 of FIG. 2 combines (e.g., concatenates) the fifth bin embeddings 312E per pixel 106 with the relative depth map 118 to generate the output array 126 of FIG. 1. In the example of FIG. 1, the output array 126 is an array of size W×H×(C+1), where C+1 represents the number of channels (e.g., C) used to represent the fifth bin embeddings 312E along with an additional channel to represent the corresponding relative depth value for one of the pixels 106. In this example, values along the W×H dimensions represent the pixel locations of the corresponding pixels 106, and values along the C+1 dimension represent the bin embeddings 312 and the relative depth values for the corresponding pixels 106.

In some examples, the dimensionality of the bin array 124 (e.g., W×H×N) is different from the dimensionality of the output array 126 (e.g., W×H×(C+1)). Thus, to enable information represented in the bin array 124 to be combined with information represented in the output array 126, the depth estimation circuitry 200 of FIG. 2 maps and/or converts the output array 126 to an example probability array (e.g., a probability matrix) 128 having the same dimensionality (e.g., W×H×N) as the bin array 124. For example, example probability calculation circuitry 216 of the depth estimation circuitry 200 of FIG. 2 provides the output array 126 to an example convolutional layer 130, where the convolutional layer 130 outputs and/or predicts one or more example probability distribution parameters for an example probability distribution to be represented in the probability array 128. In some examples, the convolutional layer 130 utilizes the relative depth values to guide estimation of one or more example probability values that a given one of the pixels 106 corresponds to a given one of the bin centers 302. In the example of FIG. 1, the probability distribution corresponds to a binomial distribution (e.g., a log binomial distribution), and the probability distribution parameters include an example mode parameter (e.g., q) and an example temperature parameter (e.g., t). In some examples, a different probability distribution (e.g., based on a softmax function) may be used instead.

In the example of FIG. 1, using the mode parameter (e.g., q) and the temperature parameter (e.g., t) output by the convolutional layer 130, the probability calculation circuitry 216 determines example probability values (e.g., probability scores) for corresponding ones of the bin centers 302 (e.g., represented in the bin array 124) based on example Equation 4 below.

$${p}_{k} = p ( k ; N , q ) = ( \begin{matrix}N \\ k\end{matrix} ) {{q}^{k} ( 1 - q )}^{N - k} \qquad ( Equation 4 )$$

In example Equation 4 above, pₖ represents the probability value corresponding to the k^{th} one of the bin centers 302 for a corresponding pixel 106, and N is the total number of the bin centers 302 determined for the corresponding pixel 106. In some examples, the probability value represent a probability that a depth value of the corresponding pixel 106 corresponds to the depth value associated with the/eh one of the bin centers 302. In some examples, the probability calculation circuitry 216 normalizes the probability values (e.g., pₖ) by determining a logarithm of the probability value(s) (e.g., log(p k)), utilizing Stirling's approximation for factorials, and applying a softmax function as shown in example Equation 5 below.

p′ₖ=softmax({log(pₖ)/t}ₖ₌₁^{N}) (Equation 5)

In example Equation 5 above, p′k represents the normalized probability values for the corresponding k^{th} one of the bin centers 302. In some examples, the probability calculation circuitry 216 generates the probability array 128 based on the probability values pₖ (or the normalized probability values p′ₖ). For example, values along the W×H dimensions of the probability array 128 represent the pixel locations for corresponding one(s) of the pixels 106, and values along the N dimension represent the probability values pₖ (or the normalized probability values p′ₖ) for the corresponding one(s) of the pixels 106.

In the example of FIG. 1, the depth estimation circuitry 200 of FIG. 2 estimates example metric depth values for the pixels 106 of the image 102 based on the bin array 124 and the probability array 128. For example, example metric depth estimation circuitry 214 of FIG. 2 combines (e.g., linearly combines) depth values for the bin centers 302 represented in the bin array 124 with corresponding one(s) of the probability values represented in the probability array 128 to determine the example metric depth values for the pixels 106. In some examples, the metric depth estimation circuitry 214 determines the linear combination(s) based on example Equation 6 below.

d(i)=Σₖ₌₁^{N}pᵢ(k)cᵢ(k) (Equation 6)

In example Equation 6 above, d(i) represents the metric depth value corresponding to an i^{th} one of the pixels 106, pᵢ(k) represents the k^{th} probability value corresponding to the one of the pixels 106, and cᵢ(k) represents the depth value at the k^{th} one of the bin centers 320 corresponding to the i^{th} one of the pixels 106. In some examples, the metric depth estimation circuitry 214 generates and/or outputs the metric depth map 104 of FIG. 1 based on the metric depth values d(i). For example, the metric depth values are represented in the metric depth map 104 based on color and/or brightness of one or more example elements 132, where one(s) of the elements 132 in the metric depth map 104 correspond to one(s) of the pixels 106 in the image 102. In the example of FIG. 1, a first example element 132A of the metric depth map 104 corresponds to the first pixel 106A of the image 102, and a second example element 132B of the metric depth map 104 corresponds to the second pixel 106B of the image 102. In this example, because the first pixel 106A corresponds to a smaller metric depth value compared to the second pixel 106B (e.g., a first object corresponding to the first pixel 106A is closer to a reference point of the image 102 compared to a second object corresponding to the second pixel 106B), the first element 132A in the metric depth map 104 has a different color and/or brightness compared to the second element 132B. In some examples, metric depth estimation circuitry 214 outputs the metric depth map 104 for presentation on an example device (e.g., a user device) and/or causes storage of the metric depth map 104 in an example database 218 of the depth estimation circuitry 200.

FIG. 2 is a block diagram of an example implementation of an example depth estimation circuitry 200 to execute the example process flow 100 of FIG. 1 and/or the example bin selection process flow 300 of FIG. 3. The depth estimation circuitry 200 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the depth estimation circuitry 200 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the illustrated example of FIG. 2, the depth estimation circuitry 200 includes example input interface circuitry 202, the example model training circuitry 204, the example encoder circuitry 206, the example domain classification circuitry 208, the example decoder circuitry 210, the example bin selection circuitry 212, the example metric depth estimation circuitry 214, the example probability calculation circuitry 216, and the example database 218.

The example database 218 stores data utilized, generated, and/or obtained by the depth estimation circuitry 200. The example database 218 of FIG. 2 is implemented by any memory, storage device and/or storage disc for storing data such as, for example, flash memory, magnetic media, optical media, solid state memory, hard drive(s), thumb drive(s), etc. Furthermore, the data stored in the example database 218 may be in any data format such as, for example, binary data, comma delimited data, tab delimited data, structured query language (SQL) structures, etc. While, in the illustrated example, the example database 218 is illustrated as a single device, the example database 218 and/or any other data storage devices described herein may be implemented by any number and/or type(s) of memories.

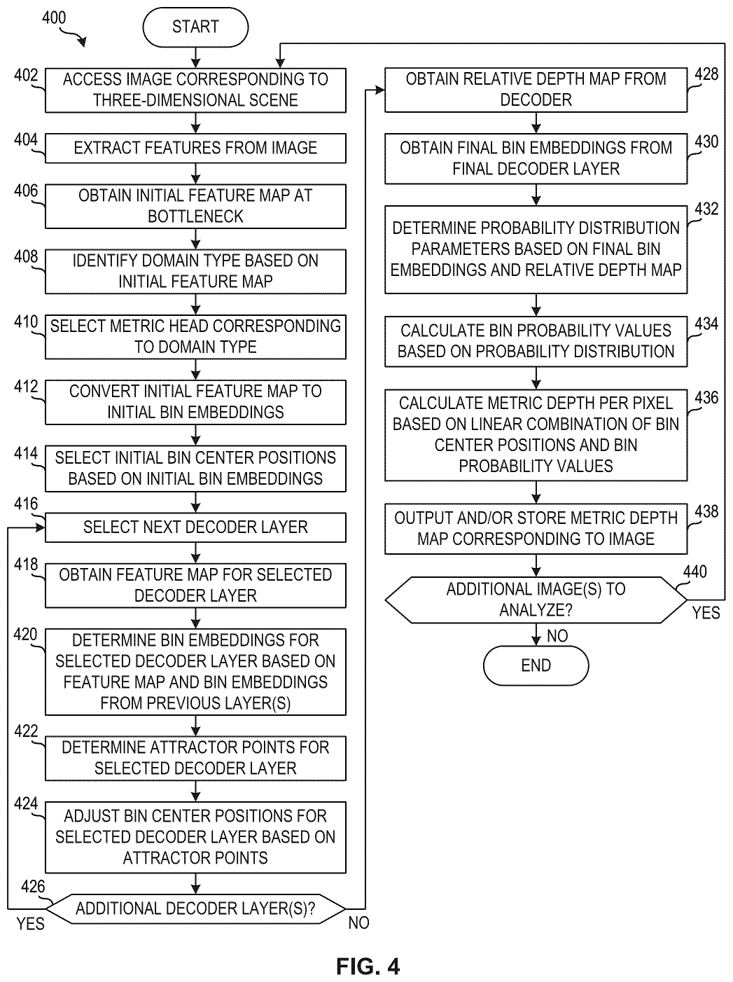

The example input interface circuitry 202 of FIG. 2 receives, accesses, and/or obtains example input data to be utilized by the depth estimation circuitry 200. For example, the input interface circuitry 202 accesses and/or obtains the example image 102 of FIG. 1 for which metric depth values are to be estimated. In some examples, the input interface circuitry 202 accesses and/or obtains the example user input(s) 220, where the user input(s) 220 can be provided by a user via an example user device (e.g., a computing device, a mobile device, etc.) communicatively coupled to the depth estimation circuitry 200. In some examples, the user input(s) 220 can indicate and/or represent selection(s) for example hyperparameter values (e.g., a mode hyperparameter value and/or a temperature hyperparameter value), an example attractor equation (e.g., the inverse attractor equation of example Equation 2 above and/or the exponential attractor equation of example Equation 3 above), a number of decoder layers 310, a number of attractors 320 per decoder layer 310, etc. In some examples, the input interface circuitry 202 is instantiated by programmable circuitry executing input interface circuitry instructions and/or configured to perform operations such as those represented by the flowchart(s) of FIG. 4.

The example model training circuitry 204 generates and/or trains one or more example models (e.g., neural network model(s)) implemented by the depth estimation circuitry 200. For example, the model training circuitry 204 generates and/or trains an example relative depth estimation model (e.g., relative depth estimation layer(s) of the neural network model(s)) to implement the encoder-decoder architecture 110 of FIG. 1, and/or one or more example metric depth estimation models (e.g., metric depth estimation layer(s) of the neural network model(s)) to implement the one or more metric heads 122 of FIG. 1. In particular, the model training circuitry 204 trains the bin embedding layer(s) 304, the bin initialization layer(s) 306, and/or the attractor selection layer(s) 308. In some examples, the model training circuitry 204 generates and/or trains the example classification model for classifying and/or identifying a domain of the image 102.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, machine learning models based on MiDaS depth estimation architectures are used. For example, the machine learning models can include a transformer-based encoder-decoder architecture (e.g., a DPT encoder-decoder architecture) as a base model (e.g., a backbone), and further include one or more metric heads (e.g., prediction heads) trained on top of the base model. While a BEiT base model is used for the MiDaS architecture in this example, one or more different base models (e.g., Swin2, Swin, EfficientNet B5, etc.) can be used instead. In general, machine learning models/architectures that are suitable to use in the example approaches disclosed herein will be convolutional neural networks (CNNs). However, other types of machine learning models could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error (e.g., based on a cross-entropy loss). As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In some examples disclosed herein, ML/AI models are trained using supervised learning. However, any other training algorithm may additionally or alternatively be used. In examples disclosed herein, training is performed until a targeted accuracy level is reached (e.g., >95%). Training is performed using hyperparameters that control how the learning is performed (e.g., a learning rate, a number of layers to be used in the machine learning model, etc.). In some examples, pre-trained model(s) are used. In some examples re-training may be performed. Such re-training may be performed in response to, for example, poor depth detection due to, for instance, low ambient lighting.

Training is performed using training data. In examples disclosed herein, the training data originates from reference data including images representative of different three-dimensional scenes. In some examples, multiple training datasets corresponding to different domain types can be used. For example, a first training dataset can include images representative of indoor scenes, and a second training dataset can include images representative of outdoor scenes. Because supervised training is used, the training data is labeled. For example, the training data can include domain labels representing the domain types of the corresponding images. Further, the training data includes ground truth depth values (e.g., actual and/or measured depth values) for the corresponding images. For example, the ground truth depth values can include metric depth values and/or relative depth values for respective pixels of the corresponding images. In some examples, the training data can include labels representing one or more features (e.g., locations of objects and/or edges, etc.) of the corresponding images.

Once training is complete, the model(s) are deployed for use as executable construct(s) that process an input and provide an output based on the network(s) of nodes and connections defined in the model(s). In examples disclosed herein, the model(s) are stored at one or more databases (e.g., the database 218 of FIG. 2). The model(s) may then be executed by the encoder circuitry 206, the domain classification circuitry 208, the decoder circuitry 210, the bin selection circuitry 212, and/or the probability calculation circuitry 216 of FIG. 2.

Once trained, the deployed model(s) may be operated in an inference phase to process data. In the inference phase, data to be analyzed (e.g., live data) is input to the model(s), and the model(s) execute to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model(s). Moreover, in some examples, the output data may undergo post-processing after it is generated by the AI model to transform the output into a useful result (e.g., a display of data, an instruction to be executed by a machine, etc.).

In some examples, output of the deployed model(s) may be captured and provided as feedback. By analyzing the feedback, an accuracy of the deployed model(s) can be determined. If the feedback indicates that the accuracy of the deployed model(s) is less than a threshold or other criterion, training of updated model(s) can be triggered using the feedback and an updated training data set, hyperparameters, etc., to generate updated, deployed model(s).

Referring to FIG. 2, the model training circuitry 204 trains the relative depth estimation model(s) (e.g., relative depth estimation neural network model(s)) of the encoder-decoder architecture 110 based on a first portion of the training data including images and relative depth values (e.g., relative depth ground truth values) corresponding to the images. In some examples, the images from a first portion of the training data can correspond to multiple different domains (e.g., both indoor and outdoor). In some examples, based on the first portion of the training data, the model training circuitry 204 trains the relative depth estimation model(s) to extract and/or output features from an input image across one or more encoder layers corresponding to the encoder 112 of FIG. 1, and up-sample the extracted features across one or more decoder layers (e.g., the decoder layers 310 of FIG. 3) corresponding to the decoder 114 of FIG. 1. In some examples, the model training circuitry 204 trains the relative depth estimation model(s) to output relative depth maps (e.g., the relative depth map 118) based on the input image(s). In some examples, the relative depth estimation model(s) are stored in the database 218 and are accessible to the encoder circuitry 206 and/or the decoder circuitry 210 of FIG. 2.

In the example of FIG. 2, the model training circuitry 204 trains the metric depth estimation model(s) (e.g., metric depth estimation neural network model(s)) of the metric head(s) 122 based on a second portion of the training data including images and metric depth values (e.g., metric depth ground truth values) corresponding to the images. In some examples, the model training circuitry 204 divides the second portion of the training data into different training sets corresponding to different domain types. For example, the model training circuitry 204 can select a first training dataset corresponding to a first domain (e.g., an indoor domain) and a second training dataset corresponding to a second domain (e.g., an outdoor domain). In some such examples, the model training circuitry 204 trains different ones of the metric depth estimation models for the different respective domains. For example, the model training circuitry 204 can train first one(s) of the metric depth estimation models based on the first training dataset, and the first one(s) of the metric depth estimation models can be implemented by a first one of the metric heads 122 (e.g., corresponding to the indoor domain). Similarly, the model training circuitry 204 can train second one(s) of the metric depth estimation models based on the second training dataset, and the second one(s) of the metric depth estimation models can be implemented by a second one of the metric heads 122 (e.g., corresponding to the outdoor domain).

In some examples, for a corresponding one of the metric heads 122, the metric depth estimation models include corresponding ones of the bin embeddings MLP(s) 304, the bin initialization MLP(s) 306, and the attractor selection MLP(s) 308. For example, the model training circuitry 204 trains the bin embeddings MLP(s) 304 based on the corresponding one(s) of the training datasets to output bin embeddings (e.g., the bin embeddings 312) based features of images input to the depth estimation circuitry 200. In some examples, the model training circuitry 204 trains the bin initialization MLP(s) 306 based on the corresponding one(s) of the training datasets to output initial bin center positions (e.g., the first bin centers 302A) based on initial bin embeddings (e.g., the first bin embeddings 312A). In some examples, the model training circuitry 204 trains the attractor selection MLP(s) 308 based on the corresponding one(s) of the training datasets to output attractor points (e.g., the attractors 320) based on the bin embeddings 312. In some examples, the metric depth estimation model(s) are stored in the database 218 and are accessible to the bin selection circuitry 212 of FIG. 2.

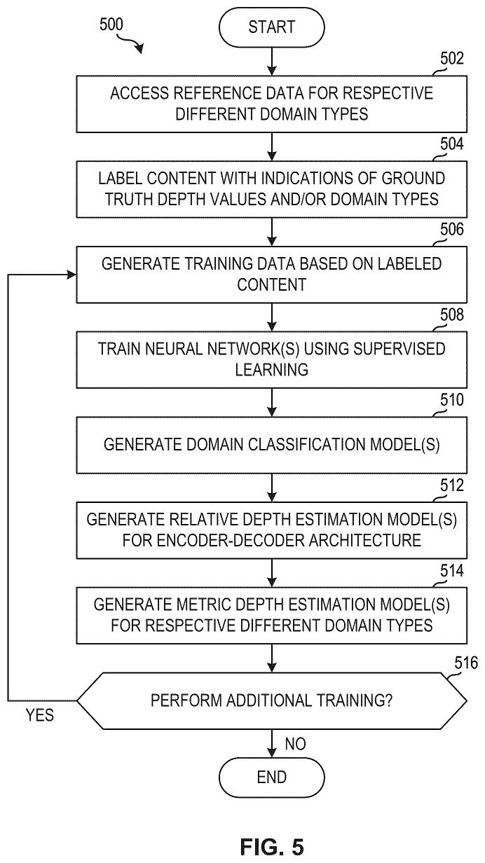

In some examples, the model training circuitry 204 trains the classification model(s) (e.g., domain classification neural network model(s)) based on the images included in the training data and the corresponding labels representing domain types of the images. For example, the model training circuitry 204 trains the classification model(s) to output a domain type (e.g., indoor or outdoor) for images input to the encoder-decoder architecture 110 of FIG. 1 based on image features extracted at the bottleneck 116. In some examples, the classification model(s) are stored in the database 218 and are accessible to the domain classification circuitry 208 of FIG. 2. In some examples, the model training circuitry 204 is instantiated by programmable circuitry executing model training circuitry instructions and/or configured to perform operations such as those represented by the flowchart(s) of FIG. 5.

The example encoder circuitry 206 of FIG. 2 implements the example encoder 112 of the example encoder-decoder architecture 110 of FIG. 1. For example, the encoder circuitry 206 executes a first portion of the relative depth estimation model(s) to extract and/or output one or more example features from the image 102 at one or more encoder layers of the encoder 112. In some examples, the encoder circuitry 206 is instantiated by programmable circuitry executing encoder circuitry instructions and/or configured to perform operations such as those represented by the flowchart(s) of FIG. 4.

The example decoder circuitry 210 of FIG. 2 implements the example decoder 114 of the encoder-decoder architecture 110. For example, the decoder circuitry 210 executes a second portion of the relative depth estimation model(s) to perform up-sampling of the latent representation(s) across subsequent one(s) of the decoder layers 310 of the decoder 114. In some examples, as a result of the up-sampling across the decoder layers 310, the decoder circuitry 210 outputs the feature maps 120 determined for corresponding ones of the decoder layers 310 and/or outputs the relative depth map 118 of FIG. 1 representing example relative depth values for the corresponding pixels 106. In some examples, the decoder circuitry 210 is instantiated by programmable circuitry executing decoder circuitry instructions and/or configured to perform operations such as those represented by the flowchart(s) of FIG. 4.

The example domain classification circuitry 208 of FIG. 2 identifies and/or predicts the domain (e.g., indoor or outdoor) of the example image 102. For example, the domain classification circuitry 208 predicts the domain by executing the example classification model(s) based on the first feature map 120A at the bottleneck 116. In some examples, the domain classification circuitry 208 selects one of the metric heads 122 of FIG. 1 implemented by the bin selection circuitry 212, the metric depth estimation circuitry 214, and/or the probability calculation circuitry 216 of FIG. 2 and corresponding to the predicted domain. In some examples, the domain classification circuitry 208 is instantiated by programmable circuitry executing domain classification circuitry instructions and/or configured to perform operations such as those represented by the flowchart(s) of FIG. 4.

The example bin selection circuitry 212 of FIG. 2 implements the example bin selection process flow 300 of FIG. 3 to select and/or adjust the bin centers 302 for one(s) of the pixels 106. For example, the bin selection circuitry 212 executes one(s) of the metric depth estimation models corresponding to the selected one of the metric heads 122. In particular, the bin selection circuitry 212 executes the bin embedding MLP(s) 304, the bin initialization MLP(s) 306, and the attractor selection MLP(s) 308 to determine the bin centers 302. In some examples, as a result of executing the bin selection process flow 300 of FIG. 3, the bin selection circuitry 212 outputs the example bin array 124 representing the bin centers 302 for corresponding one(s) of the pixels 106 of the image 102. In some examples, the bin selection circuitry 212 is instantiated by programmable circuitry executing bin selection circuitry instructions and/or configured to perform operations such as those represented by the flowchart(s) of FIG. 4.

The example probability calculation circuitry 216 of FIG. 2 determines example probability values for corresponding ones of the bin centers 302. For example, the probability calculation circuitry 216 accesses the output array 126 of FIG. 1, where the decoder circuitry 210 generates the output array by combining (e.g., concatenating) the bin embeddings 312 with the relative depth map 118. In some examples, the probability calculation circuitry 216 executes the example convolutional layer 130 of FIG. 1 based on the output array 126 to predict one or more example probability distribution parameters. In some examples, the probability calculation circuitry 216 determines the probability values based on an example probability distribution (e.g., a log binomial probability distribution) corresponding to the probability distribution parameters. In some examples, the probability calculation circuitry 216 generates and/or outputs the example probability array 128 of FIG. 1 based on the probability values. In some examples, the probability calculation circuitry 216 is instantiated by programmable circuitry executing probability calculation circuitry instructions and/or configured to perform operations such as those represented by the flowchart(s) of FIG. 4.

The example metric depth estimation circuitry 214 of FIG. 2 determines example metric depth values for corresponding one(s) of the pixels 106. For example, the metric depth estimation circuitry 214 determines the metric depth values based on a linear combination of the bin centers 302 in the bin array 124 and the probability values in the probability array 128. In some examples, the metric depth estimation circuitry 214 generates and/or outputs the example metric depth map 104 of FIG. 1 based on the probability values. In some examples, the metric depth estimation circuitry 214 is instantiated by programmable circuitry executing metric depth estimation circuitry instructions and/or configured to perform operations such as those represented by the flowchart(s) of FIG. 4.

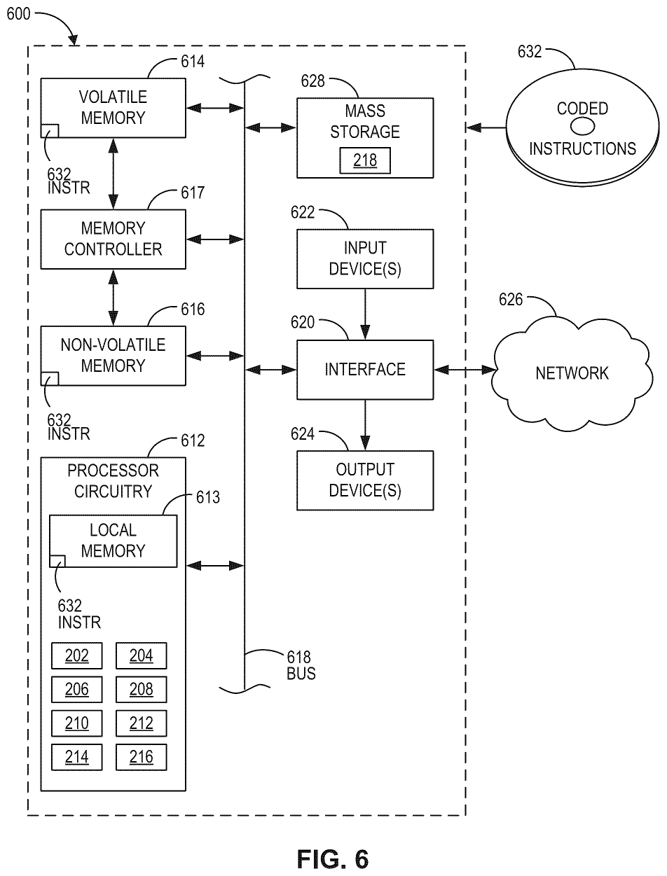

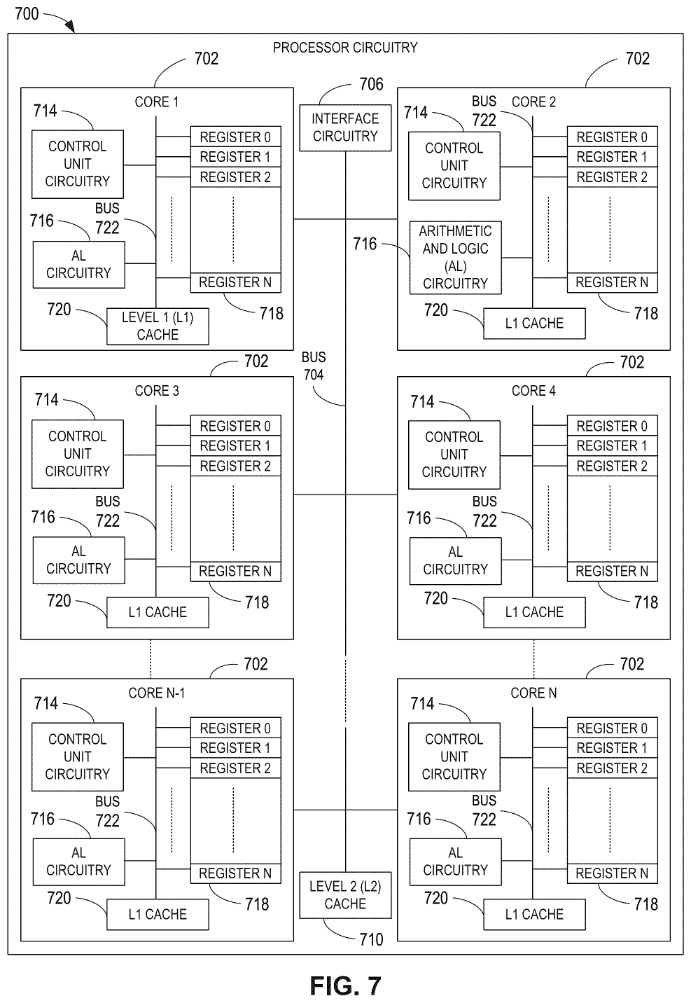

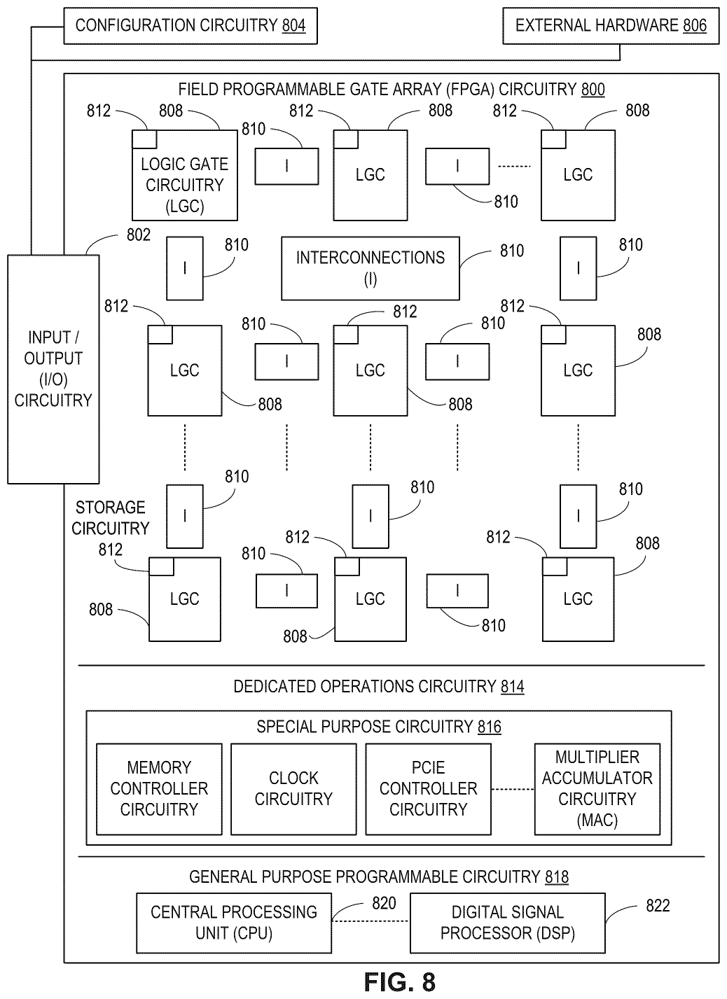

In some examples, the depth estimation circuitry 200 includes means for interfacing. For example, the means for interfacing may be implemented by the input interface circuitry 202. In some examples, the input interface circuitry 202 may be instantiated by programmable circuitry such as the example programmable circuitry 612 of FIG. 6. For instance, the input interface circuitry 202 may be instantiated by the example microprocessor 700 of FIG. 7 executing machine executable instructions such as those implemented by at least blocks 402, 440 of FIG. 4. In some examples, the input interface circuitry 202 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the input interface circuitry 202 may be instantiated by any other combination of hardware, software, and/or firmware. For example, the input interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the depth estimation circuitry 200 includes means for training. For example, the means for training may be implemented by the model training circuitry 204. In some examples, the model training circuitry 204 may be instantiated by programmable circuitry such as the example programmable circuitry 612 of FIG. 6. For instance, the model training circuitry 204 may be instantiated by the example microprocessor 700 of FIG. 7 executing machine executable instructions such as those implemented by at least blocks 502, 504, 506, 508, 510, 512, 514, 516 of FIG. 5. In some examples, the model training circuitry 204 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the model training circuitry 204 may be instantiated by any other combination of hardware, software, and/or firmware. For example, the model training circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the depth estimation circuitry 200 includes means for encoding. For example, the means for encoding may be implemented by the encoder circuitry 206. In some examples, the encoder circuitry 206 may be instantiated by programmable circuitry such as the example programmable circuitry 612 of FIG. 6. For instance, the encoder circuitry 206 may be instantiated by the example microprocessor 700 of FIG. 7 executing machine executable instructions such as those implemented by at least block 404 of FIG. 4. In some examples, the encoder circuitry 206 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the encoder circuitry 206 may be instantiated by any other combination of hardware, software, and/or firmware. For example, the encoder circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the depth estimation circuitry 200 includes means for classifying. For example, the means for classifying may be implemented by the domain classification circuitry 208. In some examples, the domain classification circuitry 208 may be instantiated by programmable circuitry such as the example programmable circuitry 612 of FIG. 6. For instance, the domain classification circuitry 208 may be instantiated by the example microprocessor 700 of FIG. 7 executing machine executable instructions such as those implemented by at least blocks 408, 410 of FIG. 4. In some examples, the domain classification circuitry 208 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the domain classification circuitry 208 may be instantiated by any other combination of hardware, software, and/or firmware. For example, the domain classification circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the depth estimation circuitry 200 includes means for decoding. For example, the means for decoding may be implemented by the decoder circuitry 210. In some examples, the decoder circuitry 210 may be instantiated by programmable circuitry such as the example programmable circuitry 612 of FIG. 6. For instance, the decoder circuitry 210 may be instantiated by the example microprocessor 700 of FIG. 7 executing machine executable instructions such as those implemented by at least blocks 406, 428, 430 of FIG. 4. In some examples, the decoder circuitry 210 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the decoder circuitry 210 may be instantiated by any other combination of hardware, software, and/or firmware. For example, the decoder circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the depth estimation circuitry 200 includes means for selecting. For example, the means for selecting may be implemented by the bin selection circuitry 212. In some examples, the bin selection circuitry 212 may be instantiated by programmable circuitry such as the example programmable circuitry 612 of FIG. 6. For instance, the bin selection circuitry 212 may be instantiated by the example microprocessor 700 of FIG. 7 executing machine executable instructions such as those implemented by at least blocks 412, 414, 416, 418, 420, 422, 424, 426 of FIG. 4. In some examples, the bin selection circuitry 212 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the bin selection circuitry 212 may be instantiated by any other combination of hardware, software, and/or firmware. For example, the bin selection circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the depth estimation circuitry 200 includes means for estimating. For example, the means for estimating may be implemented by the metric depth estimation circuitry 214. In some examples, the metric depth estimation circuitry 214 may be instantiated by programmable circuitry such as the example programmable circuitry 612 of FIG. 6. For instance, the metric depth estimation circuitry 214 may be instantiated by the example microprocessor 700 of FIG. 7 executing machine executable instructions such as those implemented by at least blocks 436, 438 of FIG. 4. In some examples, the metric depth estimation circuitry 214 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the metric depth estimation circuitry 214 may be instantiated by any other combination of hardware, software, and/or firmware. For example, the metric depth estimation circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the depth estimation circuitry 200 includes means for calculating. For example, the means for calculating may be implemented by the probability calculation circuitry 216. In some examples, the probability calculation circuitry 216 may be instantiated by programmable circuitry such as the example programmable circuitry 612 of FIG. 6. For instance, the probability calculation circuitry 216 may be instantiated by the example microprocessor 700 of FIG. 7 executing machine executable instructions such as those implemented by at least blocks 432, 434 of FIG. 4. In some examples, the probability calculation circuitry 216 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the probability calculation circuitry 216 may be instantiated by any other combination of hardware, software, and/or firmware. For example, the probability calculation circuitry 216 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the depth estimation circuitry 200 is illustrated in FIG. 2, one or more of the elements, processes, and/or devices illustrated in FIG. 2 may be combined, divided, re-arranged, omitted, eliminated, and/or implemented in any other way. Further, the example input interface circuitry 202, the example model training circuitry 204, the example encoder circuitry 206, the example domain classification circuitry 208, the example decoder circuitry 210, the example bin selection circuitry 212, the example metric depth estimation circuitry 214, the example probability calculation circuitry 216, the example database 218, and/or, more generally, the example depth estimation circuitry 200 of FIG. 2, may be implemented by hardware alone or by hardware in combination with software and/or firmware. Thus, for example, any of the example input interface circuitry 202, the example model training circuitry 204, the example encoder circuitry 206, the example domain classification circuitry 208, the example decoder circuitry 210, the example bin selection circuitry 212, the example metric depth estimation circuitry 214, the example probability calculation circuitry 216, the example database 218, and/or, more generally, the example depth estimation circuitry 200, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example depth estimation circuitry 200 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the depth estimation circuitry 200 of FIG. 2 and/or representative of example operations which may be performed by programmable circuitry to implement and/or instantiate the depth estimation circuitry 200 of FIG. 2, are shown in FIGS. 4 and/or 5. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4 and/or 5, many other methods of implementing the example depth estimation circuitry 200 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 4 and/or 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

FIG. 4 is a flowchart representative of example machine readable instructions and/or example operations 400 that may be executed, instantiated, and/or performed by programmable circuitry to estimate example metric depth values for an example image (e.g., the image 102 of FIG. 1). The example machine-readable instructions and/or the example operations 400 of FIG. 4 begin at block 402, at which the example depth estimation circuitry 200 of FIG. 2 accesses the image 102 representative of a three-dimensional scene. For example, the example input interface circuitry 202 of FIG. 2 accesses the image 102 from at least one of the example database 218 of FIG. 2, an example device (e.g., a user device, a computing device) communicatively coupled to the depth estimation circuitry 200, an example cloud-based environment, one or more network communications, etc. In some examples, the image 102 is an RGB image, where colors of the example pixels 106 of the image are represented using three example channels (e.g., representing red, green, and blue color components).

At block 404, the example depth estimation circuitry 200 extracts one or more example features from the image 102. For example, the example encoder circuitry 206 of FIG. 1 implements the example encoder 112 of the example encoder-decoder architecture 110 of FIG. 1 to extract the features from the image 102. In some examples, the features can represent, for example, an object to which one or more of the pixels 106 correspond, whether the pixels 106 correspond to a surface or an edge of the object, etc. In some examples, the encoder circuitry 206 generates one or more latent representations (e.g., encoder feature maps) at one or more layers of the encoder 112, where the latent representation(s) have a reduced spatial resolution and increased feature dimensionality compared to the image 102 input to the encoder 112.

At block 406, the example depth estimation circuitry 200 obtains an initial feature map (e.g., the first feature map 120A) at the example bottleneck 116 of the example encoder-decoder architecture 110 of FIG. 1. For example, the example decoder circuitry 210 of FIG. 2 obtains and/or accesses the first feature map 120A generated at the bottleneck 116 based on the features extracted by the encoder circuitry 206. In some examples, the first feature map 120A has a spatial resolution of 1/32 of the spatial resolution of the image 102, and the first feature map 120A represents 1024 features per pixel 106.

At block 408, the example depth estimation circuitry 200 identifies an example domain type of the image 102 based on the initial feature map (e.g., the first feature map 120A). For example, the example domain classification circuitry 208 of FIG. 2 executes an example classification model (e.g., a domain classification model, a domain classification layer) based on the first feature map 120A to predict the domain type of the image 102. In some examples, the domain type represents whether the image 102 is representative to an indoor scene or an outdoor scene.

At block 410, the example depth estimation circuitry 200 selects one of the metric heads 122 of FIG. 1 corresponding to the identified domain type. For example, the domain classification circuitry 208 selects the one of the metric heads 122 corresponding to one of the indoor domain type or the outdoor domain type identified as a result of execution of the classification model. In some examples, the domain classification circuitry 208 routes and/or provides the first feature map 120A from the bottleneck 116 to the selected one of the metric heads 122 to cause execution of one or more neural network layers.

At block 412, the example depth estimation circuitry 200 converts the initial feature map (e.g., the first feature map 120A) to example initial bin embeddings. For example, the example bin selection circuitry 212 executes the example bin embedding MLP(s) 304 corresponding to the selected one of the metric heads 122 based on the first feature map 120A. As a result of executing the bin embedding MLP(s) 304, the bin selection circuitry 212 determines and/or outputs the first example bin embeddings 312A corresponding to one(s) of the pixels 106 at the bottleneck 116. In some examples, the first bin embeddings 312A have a fixed dimensionality different from a dimensionality of the first feature map 120A.

At block 414, the example depth estimation circuitry 200 selects example initial bin center positions based on the initial bin embeddings. For example, the bin selection circuitry 212 executes the example bin initialization MLP(s) 306 corresponding to the second one of the metric heads 122 based on the first bin embeddings 312A. As a result of executing the bin initialization MLP(s) 306, the bin selection circuitry 212 determines and/or outputs example positions for the example bin centers 302 of FIG. 3 along an example depth interval 314 for corresponding one(s) of the pixels 106. In some examples, the positions of the bin centers 302 represent a distribution of metric depth values for the corresponding one(s) of the pixels 106.

At block 416, the example depth estimation circuitry 200 selects a next one of the example decoder layers 310 of FIG. 3. For example, the bin selection circuitry 212 selects the next one of the decoder layers 310 based on a sequence of the decoder layers 310 implemented by the example decoder 114 of FIG. 1.

At block 418, the example depth estimation circuitry 200 obtains one of the feature maps 120 corresponding to the selected one of the decoder layers 310. For example, the bin selection circuitry 212 obtains and/or accesses the one of the feature maps 120 generated and/or output by the decoder 114 at the selected one of the decoder layers 310.

At block 420, the example depth estimation circuitry 200 determines the example bin embeddings 312 for the selected one of the decoder layers 310. For example, the bin selection circuitry 212 executes the example bin embedding MLP(s) 304 based on the one of the feature maps 120 corresponding to the selected one of the decoder layers 310 and based on the bin embeddings 312 from a previous one of the decoder layers 310 or the bottleneck 116. As a result of executing the bin embedding MLP(s) 304, the bin selection circuitry 212 determines and/or outputs the bin embeddings 312 corresponding to one(s) of the pixels 106 at the selected one of the decoder layers 310.

At block 422, the example depth estimation circuitry 200 determines one or more example attractor points (e.g., the attractor(s) 320) for the selected one of the decoder layers 310. For example, the bin selection circuitry 212 executes the example attractor selection MLP(s) 308 based on the bin embeddings 312 for the selected one of the decoder layers 310. As a result of executing the attractor selection MLP(s) 308, the bin selection circuitry 212 determines and/or outputs positions of the attractors 320 for corresponding one(s) of the pixels 106 at the selected one of the decoder layers 310.

At block 424, the example depth estimation circuitry 200 adjusts the positions of the bin centers 302 at the selected one of the decoder layers 310 based on the attractors 320. For example, the bin selection circuitry 212 determines an adjustment value (e.g., Δcᵢ) based on the current positions of the bin centers 302 (e.g., cᵢ) and the positions of the attractors 320 (e.g., aₖ) using at least one of an example inverse attractor equation (e.g., example Equation 2 above) or an example exponential attractor equation (e.g., example Equation 3 above). In some examples, the bin selection circuitry 212 determines adjusted positions of the bin centers 302 (e.g., c′ᵢ) based on the adjustment value and the current positions of the bin centers 302 using example Equation 1 above.

At block 426, the example depth estimation circuitry 200 determines whether there are additional one(s) of the decoder layers 310 to analyze. For example, in response to the bin selection circuitry 212 determining that there are one or more additional decoder layers 310 to analyze (e.g., block 426 returns a result of YES), control returns to block 416. Alternatively, in response to the bin selection circuitry 212 determining that there are no more decoder layers 310 to analyze (e.g., block 426 returns a result of NO), control proceeds to block 428.

At block 428, the example depth estimation circuitry 200 obtains the example relative depth map 118 from the example decoder 114. For example, the example decoder circuitry 210 of FIG. 2 obtains the relative depth map 118 generated as a result of up-sampling of the features of the image 102 across one(s) of the decoder layers 310 of the decoder 114. In some examples, the relative depth map 118 represents example relative depth values for corresponding one(s) of the pixels 106.

At block 430, the example depth estimation circuitry 200 obtains final bin embeddings (e.g., the fifth bin embeddings 312E) from a final one of the decoder layers 310 (e.g., the fourth decoder layer 310D). For example, the decoder circuitry 210 obtains the fifth bin embeddings 312E generated and/or determined by the bin selection circuitry 212 for the fourth decoder layer 310D. In some examples, the decoder circuitry 210 combines (e.g., concatenates) the fifth bin embeddings 312E per pixel 106 with the relative depth map 118 to generate the output array 126 of FIG. 1.

At block 432, the example depth estimation circuitry 200 determines example probability distribution parameters based on the final bin embeddings (e.g., the fifth bin embeddings 312E) and the relative depth map 118. For example, the example probability calculation circuitry 216 of FIG. 2 provides the output array 126 to the example convolutional layer 130 of FIG. 1 to output and/or predict the probability distribution parameters for an example probability distribution represented in the example probability array 128 of FIG. 1. In some examples, the probability distribution is a log binomial distribution, and the probability distribution parameters include an example mode parameter (e.g., q) and an example temperature parameter (e.g., t).

At block 434, the example depth estimation circuitry 200 calculates example bin probability values based on the probability distribution represented in the probability array 128 of FIG. 1. For example, the probability calculation circuitry 216 calculates, based on the probability distribution parameters and example Equation 4 above, the probability values (e.g., pₖ) corresponding to ones of the bin centers 302 for corresponding one(s) of the pixels 106. In some examples, the probability calculation circuitry 216 normalizes the probability values based on example Equation 5 above.

At block 436, the example depth estimation circuitry 200 calculates and/or estimates example metric depth values per pixel 106 (e.g., d (i)) based on a linear combination of the bin center positions and the bin probability values. For example, the example metric depth estimation circuitry 214 determines a linear combination of the bin array 124 (e.g., representing final positions of the bin centers 302) and the probability array 128 based on example Equation 6 above.

At block 438, the example depth estimation circuitry 200 generates, outputs, and/or stores the example metric depth map 104 corresponding to the image 102 of FIG. 1. For example, the metric depth estimation circuitry 214 outputs the metric depth map 104 representing the metric depth values at corresponding pixels 106. In some examples, the metric depth values are represented based on the color and/or brightness of example elements 132 in the metric depth map 104. In some examples, the metric depth estimation circuitry 214 can output the metric depth map 104 for presentation on a device (e.g., a user device, a computing device) and/or can cause storage of the metric depth map 104 in the example database 218 of FIG. 2.

At block 440, the example depth estimation circuitry 200 determines whether there are one or more additional images to analyze. For example, in response to the example input interface circuitry 202 determining that there are one or more additional images to analyze (e.g., block 440 returns a result of YES), control returns to block 402. Alternatively, in response to the example input interface circuitry 202 determining that there no more images to analyze (e.g., block 440 returns a result of NO), control ends.

FIG. 5 is a flowchart representative of example machine readable instructions and/or example operations 500 that may be executed, instantiated, and/or performed by programmable circuitry to generate and/or train one or more example neural network models utilized by the example depth estimation circuitry 200 of FIG. 2. The example instructions 500 of FIG. 5, when executed by the depth estimation circuitry 200 of FIG. 2, result in one or more neural networks and/or model(s) thereof (e.g., the domain classification model(s), the relative depth estimation model(s), and/or the metric depth estimation model(s) including the bin embedding MLP(s) 304, the bin initialization MLP(s) 306, and/or the attractor selection MLP(s) 308).

The example machine-readable instructions and/or the example operations 500 of FIG. 5 begin at block 502, at which the example depth estimation circuitry 200 accesses example reference data for respective different domain types (e.g., indoor and/or outdoor). For example, the model training circuitry 204 accesses the reference data stored in the example database 218. In some examples, the reference data can include images representative of different three-dimensional scenes and/or depth values (e.g., relative depth values and/or metric depth values) corresponding to the images.

At block 504, the example depth estimation circuitry 200 labels the reference data with indications of ground truth depth values and/or domain types. For example, the model training circuitry 204 labels the reference data to indicate the ground truth depth values (e.g., the metric depth values and/or the relative depth values) and/or the domain types (e.g., indoor or outdoor) for corresponding images represented in the data. At block 506, the example model training circuitry 204 generates training data based on the labeled data. In some examples, the model training circuitry 204 separates the training data into different training datasets corresponding to respective different domain types (e.g., an indoor training dataset and an outdoor training dataset).

At block 508, the example model training circuitry 204 trains one or more neural networks using the training data. For example, the model training circuitry 204 performs training of the neural network(s) based on supervised learning. As a result of the training, the domain classification model(s) are generated at block 510. Based on the domain classification model(s), the neural network(s) are trained to identify domain types (e.g., indoor or outdoor) of images input to the encoder-decoder architecture 110 of FIG. 1. Further, at block 512, example relative depth estimation model(s) are generated for encoder-decoder architecture 110 of FIG. 1. In some examples, the neural network(s) are trained to output relative depth maps based on the images input to the encoder-decoder architecture 110. At block 514, example metric depth estimation model(s) (e.g., the bin embedding MLP(s) 304, the bin initialization MLP(s) 306, and/or the attractor selection MLP(s) 308) are generated for the respective different domain types. In some examples, the neural network(s) are trained to output metric depth maps based on the images input to the encoder-decoder architecture 110. The domain classification model(s), the relative depth estimation model(s), and/or the metric depth estimation model(s) can be stored in the database 218 of FIG. 2 for access by the encoder circuitry 206, the decoder circuitry 210, the domain classification circuitry 208, and/or the probability calculation circuitry 216 of FIG. 2. The example instructions 500 of FIG. 5 end when no additional training (e.g., retraining) is to be performed (block 516).

FIG. 6 is a block diagram of an example programmable circuitry platform 600 structured to execute and/or instantiate the example machine-readable instructions and/or the example operations of FIGS. 4 and/or 5 to implement the depth estimation circuitry 200 of FIG. 2. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the example input interface circuitry 202, the example model training circuitry 204, the example encoder circuitry 206, the example domain classification circuitry 208, the example decoder circuitry 210, the example bin selection circuitry 212, the example metric depth estimation circuitry 214, the example probability calculation circuitry 216, and the example database 218.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIGS. 4 and/or 5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 4 and/or 5 to effectively instantiate the circuitry of FIG. 2 as logic circuits to perform operations corresponding to those machine readable instructions. In some such examples, the circuitry of FIG. 2 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 4 and/or 5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged ina bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMS s), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart(s) of FIGS. 4 and/or 5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4 and/or 5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4 and/or 5. As such, the FPGA circuitry 800 may be configured and/or structured to effectively instantiate some or all of the operations/functions corresponding to the machine readable instructions of the flowchart(s) of FIGS. 4 and/or 5 as dedicated logic circuits to perform the operations/functions corresponding to those software instructions ina dedicated manner analogous to an ASIC. Therefore, the FPGA circuitry 800 may perform the operations/functions corresponding to the some or all of the machine readable instructions of FIGS. 4 and/or 5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions ina hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions ina high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtaina binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIGS. 4 and/or 5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart(s) of FIGS. 4 and/or 5 to perform first operation(s)/function(s), the FPGA circuitry 800 of FIG. 8 may be configured and/or structured to perform second operation(s)/function(s) corresponding to a second portion of the machine readable instructions represented by the flowcharts of FIGS. 4 and/or 5, and/or an ASIC may be configured and/or structured to perform third operation(s)/function(s) corresponding to a third portion of the machine readable instructions represented by the flowcharts of FIGS. 4 and/or 5.

It should be understood that some or all of the circuitry of FIG. 2 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 2 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

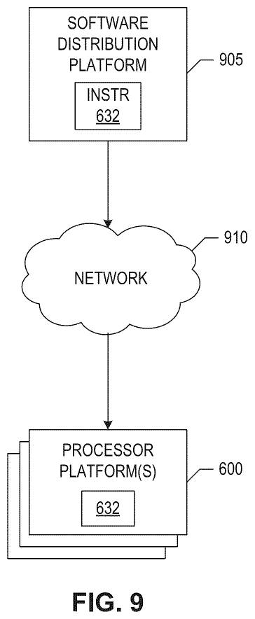

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 4 and/or 5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIGS. 4 and/or 5, may be downloaded to the example programmable circuitry platform 600, which is to execute the machine readable instructions 632 to implement the depth estimation circuitry 200. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that estimate metric depth values for single images. Examples disclosed herein train an example encoder-decoder architecture for relative depth estimation, and add one or more example metric heads trained for metric depth estimation. Examples disclosed herein estimate the metric depth values of corresponding pixels based on bin center positions output by the metric heads, where the metric heads utilize features output at different decoder layers of the encoder-decoder architecture to iteratively adjust and/or refine the bin center positions based. By utilizing information available at the different decoder layers (e.g., in addition to the information available at an output of the encoder-decoder architecture), examples disclosed herein improve accuracy of metric depth estimations for an image. As a result, disclosed systems, apparatus, articles of manufacture, and methods improve the efficiency of using a computing device by improving performance of downstream applications that utilize the metric depth estimations. Further, examples disclosed herein generate a metric depth estimation model that generalizes across multiple datasets and/or domains, thereby reducing utilization of memory and/or computational power of the computing device for re-training of the model. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture for monocular depth estimation are disclosed herein. Further examples and combinations thereof include the following:

Example 1 includes an apparatus comprising interface circuitry, and programmable circuitry to be programmed by instructions to at least determine bin center positions for a pixel of an image based on first features obtained at a first decoder layer of an encoder-decoder architecture, the image representative of a three-dimensional scene, the bin center positions corresponding to respective different metric depth values, adjust the bin center positions at a second decoder layer of the encoder-decoder architecture based on an attractor point, the attractor point based on the first features and second features obtained at the second decoder layer, and output a metric depth map corresponding to the image, the metric depth map including a metric depth value corresponding to the pixel, the metric depth value based on the adjusted bin center positions.

Example 2 includes the apparatus of example 1, wherein the programmable circuitry is to identify, based on the first features, a domain type corresponding to the image, and execute a neural network model corresponding to the domain type, the neural network model to output the bin center positions at the first decoder layer.

Example 3 includes the apparatus of example 2, wherein the domain type corresponds to at least one of an indoor scene or an outdoor scene.

Example 4 includes the apparatus of example 2, wherein the programmable circuitry is to train one or more first layers of the neural network based on relative depth training data, the one or more first layers including the first and second decoder layers, and train one or more second layers of the neural network model based on metric depth training data corresponding to the domain type.

Example 5 includes the apparatus of example 1, wherein the programmable circuitry is to obtain, with the encoder-decoder architecture, a relative depth value for the pixel, determine, based on the relative depth value and the second features, bin probability values corresponding to respective ones of the adjusted bin center positions, and determine the metric depth value based on a linear combination of the bin probability values and the respective ones of the adjusted bin center positions.

Example 6 includes the apparatus of example 5, wherein the programmable circuitry is to determine the bin probabilities values based on a log binomial distribution.

Example 7 includes the apparatus of example 1, wherein the first features correspond to a first dimensionality and the second features correspond to a second dimensionality different from the first dimensionality, and the programmable circuitry is to execute one or more neural network models to map the first features to first bin embeddings and map the second features to second bin embeddings, the first bin embeddings and the second bin embeddings corresponding to a third dimensionality different from the first and second dimensionalities.

Example 8 includes the apparatus of example 7, wherein the programmable circuitry is to determine the bin center positions at the first decoder layer based on the first bin embeddings, select the attractor point based on the second bin embeddings, calculate an adjustment value based on differences between the bin center positions and the attractor point, and adjust the bin center positions at the second decoder layer based on the adjustment value.

Example 9 includes a non-transitory computer readable medium comprising instructions to cause programmable circuitry to at least determine bin center positions for a pixel of an image based on first features obtained at a first decoder layer of an encoder-decoder architecture, the image representative of a three-dimensional scene, the bin center positions corresponding to respective different metric depth values, adjust the bin center positions at a second decoder layer of the encoder-decoder architecture based on an attractor point, the attractor point based on the first features and second features obtained at the second decoder layer, and output a metric depth map corresponding to the image, the metric depth map including a metric depth value corresponding to the pixel, the metric depth value based on the adjusted bin center positions.

Example 10 includes the non-transitory computer readable medium of example 9, wherein the instructions are to cause the programmable circuitry to identify, based on the first features, a domain type corresponding to the image, and execute a neural network model corresponding to the domain type, the neural network model to output the bin center positions at the first decoder layer.

Example 11 includes the non-transitory computer readable medium of example 10, wherein the domain type corresponds to at least one of an indoor scene or an outdoor scene.

Example 12 includes the non-transitory computer readable medium of example 10, wherein the instructions are to cause the programmable circuitry to train one or more first layers of the neural network based on relative depth training data, the one or more first layers including the first and second decoder layers, and train one or more second layers of the neural network model based on metric depth training data corresponding to the domain type.

Example 13 includes the non-transitory computer readable medium of example 9, wherein the instructions are to cause the programmable circuitry to obtain, with the encoder-decoder architecture, a relative depth value for the pixel, determine, based on the relative depth value and the second features, bin probability values corresponding to respective ones of the adjusted bin center positions, and determine the metric depth value based on a linear combination of the bin probability values and the respective ones of the adjusted bin center positions.

Example 14 includes the non-transitory computer readable medium of example 13, wherein the instructions are to cause the programmable circuitry to determine the bin probabilities values based on a log binomial distribution.

Example 15 includes the non-transitory computer readable medium of example 9, wherein the first features correspond to a first dimensionality and the second features correspond to a second dimensionality different from the first dimensionality, and the instructions are to cause the programmable circuitry to execute one or more neural network models to map the first features to first bin embeddings and map the second features to second bin embeddings, the first bin embeddings and the second bin embeddings corresponding to a third dimensionality different from the first and second dimensionalities.

Example 16 includes the non-transitory computer readable medium of example 15, wherein the instructions are to cause the programmable circuitry to determine the bin center positions at the first decoder layer based on the first bin embeddings, select the attractor point based on the second bin embeddings, calculate an adjustment value based on differences between the bin center positions and the attractor point, and adjust the bin center positions at the second decoder layer based on the adjustment value.

Example 17 includes an apparatus comprising bin selection circuitry to determine bin center positions for a pixel of an image based on first features obtained at a first decoder layer of an encoder-decoder architecture, the image representative of a three-dimensional scene, the bin center positions corresponding to respective different metric depth values, and adjust the bin center positions at a second decoder layer of the encoder-decoder architecture based on an attractor point, the attractor point based on the first features and second features obtained at the second decoder layer, and metric depth estimation circuitry to output a metric depth map corresponding to the image, the metric depth map including a metric depth value corresponding to the pixel, the metric depth value based on the adjusted bin center positions.

Example 18 includes the apparatus of example 17, further including domain classification circuitry to identify, based on the first features, a domain type corresponding to the image, and cause execution of a neural network model corresponding to the domain type, the neural network model to output the bin center positions at the first decoder layer.

Example 19 includes the apparatus of example 18, wherein the domain type corresponds to at least one of an indoor scene or an outdoor scene.

Example 20 includes the apparatus of example 18, further including model training circuitry to train one or more first layers of the neural network based on relative depth training data, the one or more first layers including the first and second decoder layers, and train one or more second layers of the neural network model based on metric depth training data corresponding to the domain type.

Example 21 includes the apparatus of example 17, further including probability calculation circuitry to obtain, from the encoder-decoder architecture, a relative depth value for the pixel, and determine, based on the relative depth value and the second features, bin probability values corresponding to respective ones of the adjusted bin center positions, the metric depth estimation circuitry to determine the metric depth value based on a linear combination of the bin probability values and the respective ones of the adjusted bin center positions.

Example 22 includes the apparatus of example 21, wherein the probability calculation circuitry is to determine the bin probabilities values based on a log binomial distribution.

Example 23 includes the apparatus of example 17, wherein the first features correspond to a first dimensionality and the second features correspond to a second dimensionality different from the first dimensionality, and the bin selection circuitry is to map the first features to first bin embeddings and map the second features to second bin embeddings, the first bin embeddings and the second bin embeddings corresponding to a third dimensionality different from the first and second dimensionalities.

Example 24 includes the apparatus of example 23, wherein the bin selection circuitry is to determine the bin center positions at the first decoder layer based on the first bin embeddings, select the attractor point based on the second bin embeddings, calculate an adjustment value based on differences between the bin center positions and the attractor point, and adjust the bin center positions at the second decoder layer based on the adjustment value.

Example 25 includes a method comprising determining bin center positions for a pixel of an image based on first features obtained at a first decoder layer of an encoder-decoder architecture, the image representative of a three-dimensional scene, the bin center positions corresponding to respective different metric depth values, adjusting the bin center positions at a second decoder layer of the encoder-decoder architecture based on an attractor point, the attractor point based on the first features and second features obtained at the second decoder layer, and outputting a metric depth map corresponding to the image, the metric depth map including a metric depth value corresponding to the pixel, the metric depth value based on the adjusted bin center positions.

Example 26 includes the method of example 25, further including identifying, based on the first features, a domain type corresponding to the image, and executing a neural network model corresponding to the domain type, the neural network model to output the bin center positions at the first decoder layer.

Example 27 includes the method of example 26, wherein the domain type corresponds to at least one of an indoor scene or an outdoor scene.

Example 28 includes the method of example 26, further including training one or more first layers of the neural network based on relative depth training data, the one or more first layers including the first and second decoder layers, and training one or more second layers of the neural network model based on metric depth training data corresponding to the domain type.

Example 29 includes the method of example 25, further including obtaining, with the encoder-decoder architecture, a relative depth value for the pixel, determining, based on the relative depth value and the second features, bin probability values corresponding to respective ones of the adjusted bin center positions, and determining the metric depth value based on a linear combination of the bin probability values and the respective ones of the adjusted bin center positions.

Example 30 includes the method of example 29, further including determining the bin probabilities values based on a log binomial distribution.

Example 31 includes the method of example 25, wherein the first features correspond to a first dimensionality and the second features correspond to a second dimensionality different from the first dimensionality, further including executing one or more neural network models to map the first features to first bin embeddings and map the second features to second bin embeddings, the first bin embeddings and the second bin embeddings corresponding to a third dimensionality different from the first and second dimensionalities.

Example 32 includes the method of example 31, further including determining the bin center positions at the first decoder layer based on the first bin embeddings, selecting the attractor point based on the second bin embeddings, calculating an adjustment value based on differences between the bin center positions and the attractor point, and adjusting the bin center positions at the second decoder layer based on the adjustment value.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry; and
programmable circuitry to be programmed by instructions to at least:
determine bin center positions for a pixel of an image based on first features obtained at a first decoder layer of an encoder-decoder architecture, the image representative of a three-dimensional scene, the bin center positions corresponding to respective different metric depth values;
adjust the bin center positions at a second decoder layer of the encoder-decoder architecture based on an attractor point, the attractor point based on the first features and second features obtained at the second decoder layer; and
output a metric depth map corresponding to the image, the metric depth map including a metric depth value corresponding to the pixel, the metric depth value based on the adjusted bin center positions.

2. The apparatus of claim 1, wherein the programmable circuitry is to:
identify, based on the first features, a domain type corresponding to the image; and
execute a neural network model corresponding to the domain type, the neural network model to output the bin center positions at the first decoder layer.

3. The apparatus of claim 2, wherein the domain type corresponds to at least one of an indoor scene or an outdoor scene.

4. The apparatus of claim 2, wherein the programmable circuitry is to:
train one or more first layers of the neural network based on relative depth training data, the one or more first layers including the first and second decoder layers; and
train one or more second layers of the neural network model based on metric depth training data corresponding to the domain type.

5. The apparatus of claim 1, wherein the programmable circuitry is to:
obtain, with the encoder-decoder architecture, a relative depth value for the pixel;
determine, based on the relative depth value and the second features, bin probability values corresponding to respective ones of the adjusted bin center positions; and
determine the metric depth value based on a linear combination of the bin probability values and the respective ones of the adjusted bin center positions.

6. The apparatus of claim 5, wherein the programmable circuitry is to determine the bin probabilities values based on a log binomial distribution.

7. The apparatus of claim 1, wherein the first features correspond to a first dimensionality and the second features correspond to a second dimensionality different from the first dimensionality, and the programmable circuitry is to execute one or more neural network models to map the first features to first bin embeddings and map the second features to second bin embeddings, the first bin embeddings and the second bin embeddings corresponding to a third dimensionality different from the first and second dimensionalities.

8. The apparatus of claim 7, wherein the programmable circuitry is to:
determine the bin center positions at the first decoder layer based on the first bin embeddings;
select the attractor point based on the second bin embeddings;
calculate an adjustment value based on differences between the bin center positions and the attractor point; and
adjust the bin center positions at the second decoder layer based on the adjustment value.

9. A non-transitory computer readable medium comprising instructions to cause programmable circuitry to at least:
determine bin center positions for a pixel of an image based on first features obtained at a first decoder layer of an encoder-decoder architecture, the image representative of a three-dimensional scene, the bin center positions corresponding to respective different metric depth values;
adjust the bin center positions at a second decoder layer of the encoder-decoder architecture based on an attractor point, the attractor point based on the first features and second features obtained at the second decoder layer; and
output a metric depth map corresponding to the image, the metric depth map including a metric depth value corresponding to the pixel, the metric depth value based on the adjusted bin center positions.

10. The non-transitory computer readable medium of claim 9, wherein the instructions are to cause the programmable circuitry to:
identify, based on the first features, a domain type corresponding to the image; and
execute a neural network model corresponding to the domain type, the neural network model to output the bin center positions at the first decoder layer.

11. The non-transitory computer readable medium of claim 10, wherein the domain type corresponds to at least one of an indoor scene or an outdoor scene.

12. The non-transitory computer readable medium of claim 10, wherein the instructions are to cause the programmable circuitry to:
train one or more first layers of the neural network based on relative depth training data, the one or more first layers including the first and second decoder layers; and
train one or more second layers of the neural network model based on metric depth training data corresponding to the domain type.

13. The non-transitory computer readable medium of claim 9, wherein the instructions are to cause the programmable circuitry to:
obtain, with the encoder-decoder architecture, a relative depth value for the pixel;
determine, based on the relative depth value and the second features, bin probability values corresponding to respective ones of the adjusted bin center positions; and
determine the metric depth value based on a linear combination of the bin probability values and the respective ones of the adjusted bin center positions.

14. The non-transitory computer readable medium of claim 13, wherein the instructions are to cause the programmable circuitry to determine the bin probabilities values based on a log binomial distribution.

15. The non-transitory computer readable medium of claim 9, wherein the first features correspond to a first dimensionality and the second features correspond to a second dimensionality different from the first dimensionality, and the instructions are to cause the programmable circuitry to execute one or more neural network models to map the first features to first bin embeddings and map the second features to second bin embeddings, the first bin embeddings and the second bin embeddings corresponding to a third dimensionality different from the first and second dimensionalities.

16. The non-transitory computer readable medium of claim 15, wherein the instructions are to cause the programmable circuitry to:
determine the bin center positions at the first decoder layer based on the first bin embeddings;
select the attractor point based on the second bin embeddings;
calculate an adjustment value based on differences between the bin center positions and the attractor point; and
adjust the bin center positions at the second decoder layer based on the adjustment value.

17. An apparatus comprising:
bin selection circuitry to:
determine bin center positions for a pixel of an image based on first features obtained at a first decoder layer of an encoder-decoder architecture, the image representative of a three-dimensional scene, the bin center positions corresponding to respective different metric depth values; and
adjust the bin center positions at a second decoder layer of the encoder-decoder architecture based on an attractor point, the attractor point based on the first features and second features obtained at the second decoder layer; and
metric depth estimation circuitry to:
output a metric depth map corresponding to the image, the metric depth map including a metric depth value corresponding to the pixel, the metric depth value based on the adjusted bin center positions.

18. The apparatus of claim 17, further including domain classification circuitry to:
identify, based on the first features, a domain type corresponding to the image; and
cause execution of a neural network model corresponding to the domain type, the neural network model to output the bin center positions at the first decoder layer.

19. The apparatus of claim 18, wherein the domain type corresponds to at least one of an indoor scene or an outdoor scene.

20. The apparatus of claim 18, further including model training circuitry to:
train one or more first layers of the neural network based on relative depth training data, the one or more first layers including the first and second decoder layers; and
train one or more second layers of the neural network model based on metric depth training data corresponding to the domain type.

21-24. (canceled)
